(19) United States
(12) Patent Application Publication
(10) Pub. No.: US 2007/0034431 A1
(43) Pub. Date: Feb. 15, 2007

(54) Governor guard

(76) Inventor: Vincent Edward Jackson, Burr Ridge, IL (US)

Correspondence Address: FACTOR & LAKE, LTD, 1327 W. WASHINGTON BLVD., SUITE 5G/H, CHICAGO, IL, 60607, US

(21) Appl. No.: 11/200,221

(22) Filed: Aug. 9, 2005

(51) Int. Cl. B62D 25/10

(52) U.S. Cl. 180/69.2

(57) ABSTRACT

An apparatus and method is disclosed for inhibiting the possibility of tampering with a governor associated with an engine. According to one aspect of the invention, a cover is provided having a base and at least one attachment arm extending therefrom. Further, a bolt is coupled to the attachment arm and the cover is mounted to at least partially cover the governor. In accordance with another aspect of the invention, a method is provided. The method includes placing a cover within an engine compartment wherein the cover envelopes at least a portion of a governor. The method also includes fastening the cover within the engine compartment with a hand tool.

### FIELD OF THE INVENTION

The present invention relates to tamper prevention guards or covers, and in particular to a cover for reducing the potential to tamper with a governor for an engine.

### RELATED APPLICATIONS

None.

### FEDERALLY SPONSORED RESEARCH OR DEVELOPMENT

None.

### BACKGROUND OF THE INVENTION

Typically, a governor is a mechanical attachment to a machine, such as a gasoline engine, for limiting speed. By using a governor, the life expectance of the engine is maintained by protecting the engine from achieving excessive speeds.

Nevertheless, a user of an engine, such as a golf cart driver, may desire that the engine operate at an excessive speed. Also, persons may intentionally or non-intentionally tamper with the governor to change the available operating speed of the engine.

The unique invention disclosed herein provides a solution to inhibit the potential for tampering with a governor associated with an engine.

### SUMMARY OF INVENTION

The present invention is directed to a guard or cover that reduces the accessibility, and thus the potential, for tampering with a governor that limits the speed of an engine. According to one aspect of the invention, a cover is mounted at least partially over the governor. The cover includes a base panel or plate and at least one attachment arm extending therefrom. Further, a bolt can be coupled to the attachment arm.

According to another aspect of the invention, a method is provided. The method includes placing a cover within an engine compartment wherein the cover envelopes at least a portion of the governor. The method also includes fastening the cover within the engine compartment with a hand tool.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### DESCRIPTION OF THE DRAWINGS

The invention may be better understood with reference to the following drawings. The components in the drawings are not necessarily to scale, emphasis instead being placed upon illustrating the principles of the invention. In the drawings, like reference numerals designate corresponding parts throughout the several views.

FIG. 1 is a perspective view of a golf cart having an engine compartment for containing an apparatus in accordance with the present invention;

FIG. 2 is a plan view of a fabricated sheet of metal or metal alloy prior to being shaped or bent;

FIG. 3 is a perspective view of an apparatus in accordance with the present invention, the apparatus comprising the fabricated sheet of FIG. 2 after being shaped or bent;

FIG. 4 is a perspective view of a fastener in accordance with the present invention for securing the apparatus of FIG. 3 within the engine compartment of the golf cart of FIG. 1;

FIG. 5 is an exploded perspective view of the apparatus of FIG. 3 within the engine compartment of the golf cart of FIG. 1; and,

FIG. 6 is a perspective view of the apparatus of FIG. 3 secured within the engine compartment of the golf cart of FIG. 1.

### DESCRIPTION OF DETAILED EMBODIMENTS

The following descriptions of detailed embodiments are for exemplifying the principles and advantages of the inventions claimed herein. They are not to be taken in any way as limitations on the scope of the inventions.

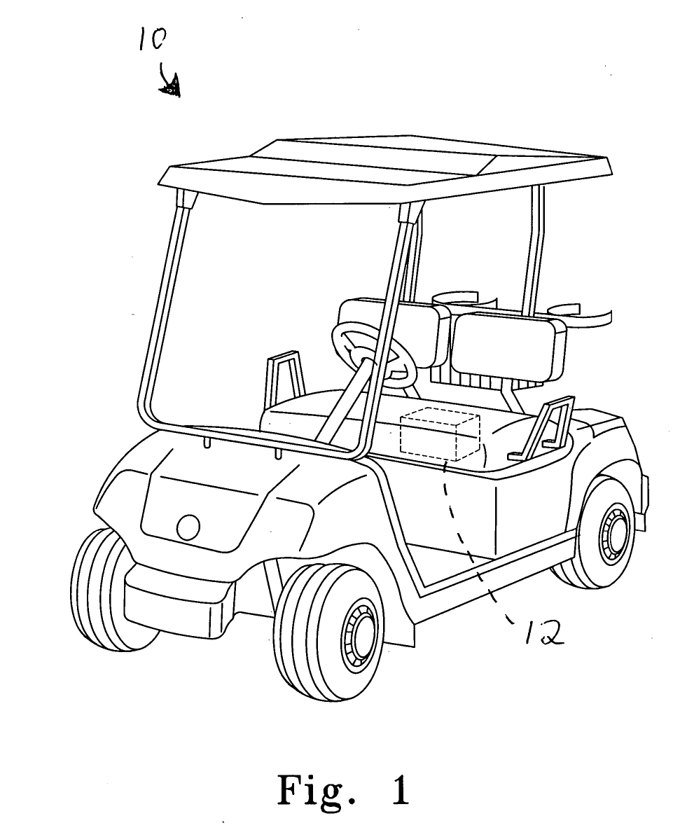

Turning to the FIGURES, and in particular to FIG. 1, a motorized vehicle 10 is depicted having an engine compartment 12 for containing an apparatus in accordance with the present invention. The motorized vehicle 10 shown is a golf cart. However, as will be appreciated by those having ordinary skill in the art, the present invention is applicable to other motorized vehicles such as, but not limited to, all terrain vehicles, motorcycles, snowmobiles, personal watercraft, karts, and the like.

The engine compartment 12 provides a space wherein the engine for the motorized vehicle and its associated governor are mounted. In an embodiment, the engine is a conventional golf cart engine having two cylinders.

Access to the engine compartment 12 can be provided by conventional means such as, but not limited to, a movable cover or hood. Accordingly, the cover or hood can be constructed of a metal, metal alloy, plastic, or the like. The cover or hood can also have structures mounted thereon such as a seat or ornamentation. In yet an alternative embodiment, access to the engine compartment can be freely provided by the lack of a cover or hood, such as typically found on motorcycles and all terrain vehicles.

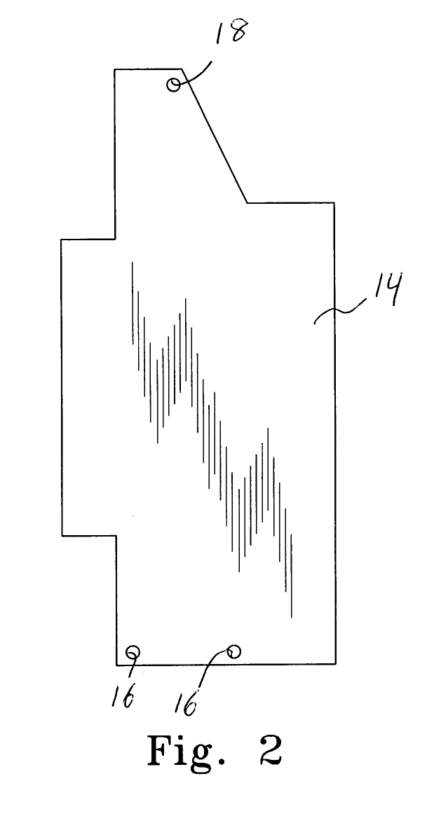

Turning to FIG. 2, a fabricated sheet 14 of metal or metal alloy material is depicted in accordance with the present invention prior to being shaped or bent. In an embodiment, the fabricated sheet 14 is sixteen gauge steel.

The sheet 14 can have a plurality of apertures or through holes 16 located at one end, and another aperture or through hole 18 located at the opposite end. The sheet 14 can be cut from a larger sheet of material or fabricated using other conventional means.

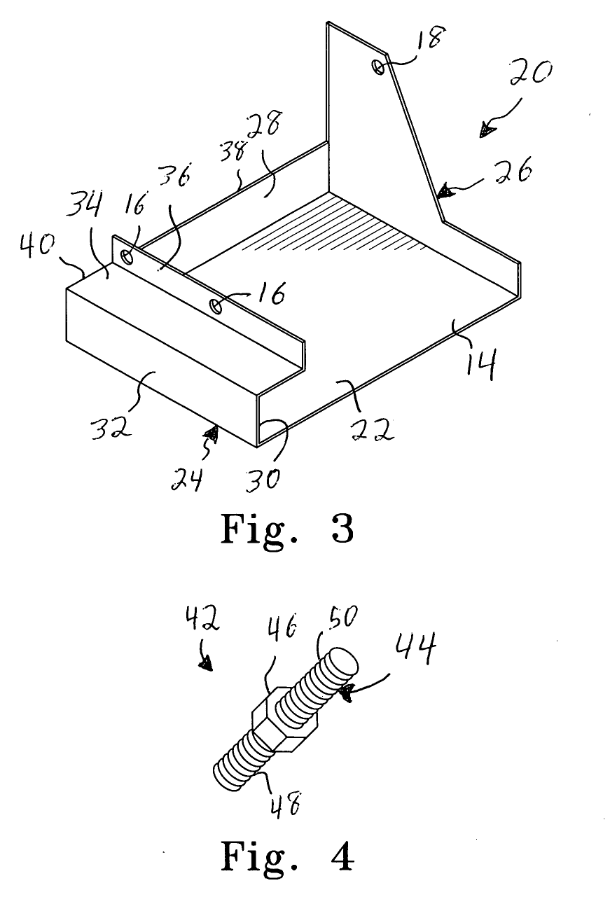

Turning to FIG. 3, a guard or cover 20 in accordance with the present invention is depicted comprising the fabricated sheet 14 of FIG. 2 after being shaped or bent. The fabricated sheet 14 can be bent by conventional means such as, but not limited to, placing the sheet or portions thereof within a metal press.

The cover 20 includes, but is not limited to, a base portion or panel 22, a pair of arms 24,26, and an overhang or rear panel portion 28. In an embodiment, the base 22 is rectangular with the arms 24,26 extending from opposite ends of the base. The first arm 24 is fashioned to provide a concave channel or cavity 30. Further, the arms can, but not necessarily, have discreet curvilinear or planar sections.

In the embodiment shown in FIG. 3, arm 24 has planar sections comprising a proximal or inner panel portion 32, a medial or middle panel portion 34, and a distal or outer panel portion 36 having through holes 16. As such, the proximal panel 32 extends from the base 22 of the cover 20, the medial panel 34 extends from the proximal panel 32, and the distal panel 36 extends from the medial panel 34.

Moreover, the proximal panel 32 is perpendicular to the base 22 of the cover 20, and is in coplanar spaced parallel alignment with the second arm 26. Likewise, the distal panel 36 is in spaced perpendicular alignment with the base 22 of the cover 20, and parallel to the second arm 26. Whereas the medial panel 34 is perpendicular to both the proximal panel 32 and the distal panel 36, and parallel to the base 22 of the cover 20.

As indicated previously, the cover 20 provides a channel or cavity 30. In an embodiment, the channel 30 is generally U-shaped, and formed by a portion of the base 22 and the proximal and medial portions of arm 24.

As also indicated previously, arm 26 extends perpendicularly from the base 22 of the cover 20, with through hole 18 located about the distal end of the arm. Further, arm 26 is in coplanar spaced parallel alignment with the proximal panel 32 and the distal panel portion 36 of arm 24.

The overhang or rear panel portion 28 is perpendicular to the base 22 of the cover 20 and the arms 24 and 26. In an embodiment, but not necessarily, a portion of the terminal end 38 of the rear panel 38 is near or adjoins a side 40 of the medial panel 34 of arm 24. Thus, the rear panel 28 covers one end of the channel 30.

Turning to FIG. 4, a fastener 42 is depicted in accordance with the present invention. As shown, the fastener 42 is a bolt 44 having a head 46 with a pair of threaded shafts 48,50 extending from the head and in coaxial alignment with each other.

Preferably, but not necessarily, at least a portion of the bolt 44 can be an original part of the engine or engine assembly. In particular, the original bolt can have only one threaded shaft extending from the head, and, in constructing the fastener, the other threaded shaft can be attached to the head by welding or other conventional means.

In yet an alternative embodiment, the fastener 42 can be a single threaded shaft with a nut threaded on the shaft. The nut can be spot welded or the like to the threaded shaft for securing the position of the nut on the shaft. However, as will be appreciated by those having ordinary skill in the art, the fastener can be any conventional means for securing the cover 20 within the engine compartment 12 such as, but not limited to, conventional bolts, nuts, screws, welds, spot welds, or other fastener methodologies.

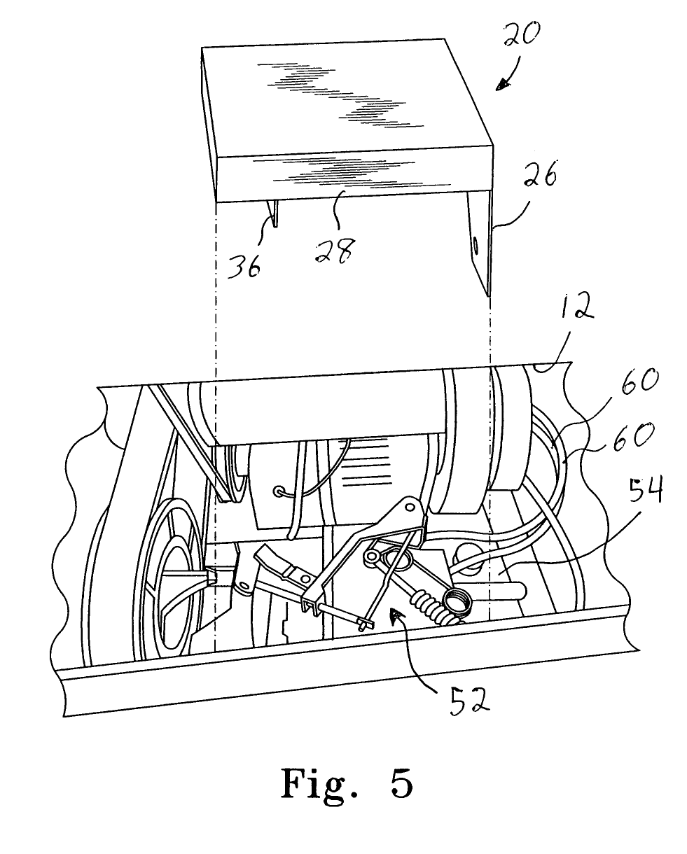

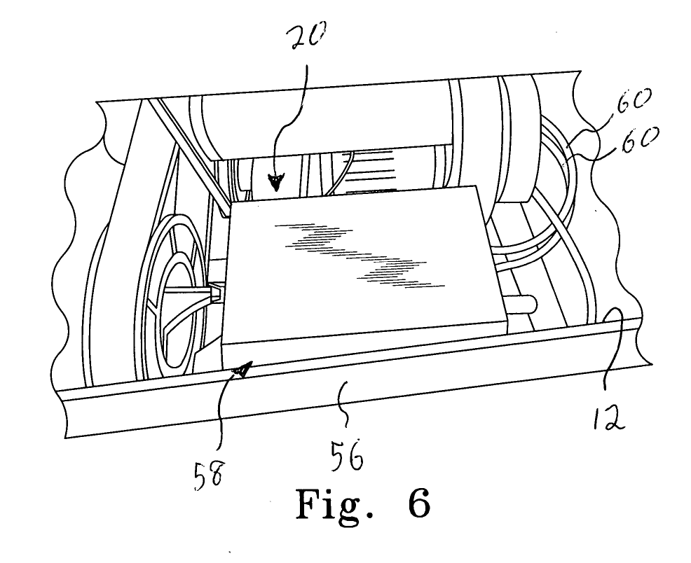

Turning to FIG. 5, an exploded view is provided of the cover 20 installed within the engine compartment 12. Preferably, the cover 20 is secured such that the cover at least partially envelopes the governor 52 to the engine 54. Stated another way, it is desired that the cover 20 be positioned to conceal, in part or preferably in full, the governor 52 when the hood to the engine compartment 12 is opened as shown in FIG. 6. Thus, easy access to the governor 52 is prevented.

The cover 20 can also extend close to portions of the engine compartment 12 or structures in the engine compartment, such as vehicle chassis frame member 56, to prevent access to the governor 52 via access between the cover and the other structure(s). For instance, as shown in FIG. 6, the spacing 58 between the cover rear panel 28 and the frame 58 can be sufficiently close to prevent a hand from reaching underneath the cover to access the governor 52.

As indicated previously, the cover 20 is secured within the engine compartment 12. Preferably, but not necessarily, the cover 20 is secured by using original fasteners, such as bolts, that have been modified as shown in FIG. 4. For instance, original fasteners can be removed from the engine 54 or other fixture(s) within the engine compartment 12. The fasteners can then be modified and secured back to their original positions on the engine 54 or within the engine compartment 12. Next, the cover 20 can be attached by inserting the exposed threaded shafts of the bolts within the apertures or holes 16,18 in the cover. Then, nuts (not shown) can be installed on the threaded shafts to secure the cover 20.

Preferably, a conventional hand tool such as a wrench, screwdriver, or the like is used in tightening the fasteners to secure the cover 20 within the engine compartment 12. This will further inhibit potential tampering with the governor 52 because a hand tool will be required to remove the cover 20, instead of a person being able to reposition or remove the cover by hand.

Turning back to FIGS. 3 and 5, the cavity or channel 30 within the cover 20 provides for receiving portions of the governor 52, while preventing tampering with the governor by a person attempting to reach under or around the cover. In particular, the medial panel 34 provides protection from a person reaching underneath the cover 20.

Moreover, the channel 30 can receive, and thus cup around, a portion or portions of the governor 52. Accordingly, parts associated with the governor 52 or the engine (e.g., the carburetor) are allowed to move within the channel.

Desirably, spacing is provided between the cover 20 and the engine to allow for control wires or cables 60 to extend under the cover. For instance, the cables 60 can provide for controlling the choke and throttle to the engine carburetor. Further, spacing can be provided between the cover 20 and the engine to allow for the passage of air underneath the cover 20 and into a carburetor. However, it is desired that the spacing not be sufficiently large enough to allow for fingers of a human hand to reach under the cover 20 and manipulate the governor 52.

It should be emphasized that the above-described embodiments of the present invention, particularly, any “preferred” embodiments, are possible examples of implementations merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention, and protected by the following claims.

What is claimed is:

1. An apparatus for at least partially covering a governor to an engine comprising:
a cover comprising a base and at least one attachment arm having an aperture and extending from the base;
a bolt coupled to the attachment arm; and,
wherein the cover is mounted at least partially over the governor.

2. The apparatus of claim 1, wherein the engine is within a golf cart.

3. The apparatus of claim 1, wherein the engine has two cylinders or less.

4. The apparatus of claim 1, wherein another attachment arm extends from the base.

5. The apparatus of claim 1, wherein the cover provides a channel.

6. The apparatus of claim 1, wherein the cover provides a channel and at least a portion of the governor extends within the channel.

7. The apparatus of claim 1, wherein the bolt has threaded shafts extending from both sides of a head.

8. An apparatus for at least partially covering a governor within an engine compartment having an opening, the apparatus comprising:
a cover within the engine compartment and enveloping at least a portion of the governor;
at least one fastener coupled to the cover; and,
wherein a hand tool is required to uncouple the fastener from the cover.

9. The apparatus of claim 8, wherein the engine is within a golf cart.

10. The apparatus of claim 8, wherein the engine has two cylinders or less.

11. The apparatus of claim 8, wherein another attachment arm extends from the base.

12. The apparatus of claim 8, wherein the cover provides a channel.

13. The apparatus of claim 8, wherein the cover provides a channel and at least a portion of the governor extends within the channel.

14. The apparatus of claim 8, wherein the bolt has threaded shafts extending from both sides of a head.

15. A method installing a cover at least partially over a governor within an engine compartment comprising the steps of:
placing the cover within the engine compartment;
enveloping at least a portion of the governor with the cover to prevent fingers from being able to manipulate the governor;
fastening, with a hand tool, the cover within the engine compartment.

16. The method of claim 15, further comprising the steps of removing a fastener from a golf cart and installing the cover within the golf cart.

17. The method of claim 15, further comprising the steps of removing a fastener from a golf cart, modifying the fastener, and installing the cover within the golf cart with the modified fastener.

18. The method of claim 15, further comprising the step of providing a fastener, comprising threaded shafts extending from both sides of a head, for fastening the cover within the engine compartment.

19. The method of claim 15, further comprising the step of cupping at least a portion of the governor with at least a portion of the cover.

20. The method of claim 15, further comprising the steps of attaching a threaded shaft to a fastener and coupling the fastener to the cover.
